(19) United States
(12) Patent Application Publication
(10) Pub. No.: US 2021/0199044 A1
(43) Pub. Date: Jul. 1, 2021

(54) METHOD FOR CONTROLLING AN ELECTRIFIED TURBOCHARGER OF AN INTERNAL COMBUSTION ENGINE, AND A MOTOR VEHICLE WITH AN INTERNAL COMBUSTION ENGINE

(71) Applicant: BMTS Technology (Shanghai) Co. Ltd., Shanghai (CN)

(72) Inventors: Gele Aori, Shanghai (CN); Wenyue Cao, Shanghai (CN); Yuehong Diao, Shanghai (CN); Jinlong Liu, Shanghai (CN); Yidong Shen, Shanghai (CN); Yunfei Wang, Shanghai (CN); Renquan Zhang, Shanghai (CN); Zongli Zhao, Shanghai (CN)

(21) Appl. No.: 17/134,412

(22) Filed: Dec. 27, 2020

(30) Foreign Application Priority Data
Dec. 31, 2019 (CN) 201911415015.3

(51) Int. Cl. F02B 37/00; F02B 37/18; F02B 37/24; F02B 39/10; F02B 39/16; F02M 35/10; F02D 41/00; F02C 6/12; H02K 7/18; H02K 7/20; H02K 11/00

(52) U.S. Cl. CPC F02B 37/005; F02B 37/183; F02B 37/24; F02B 39/10; F02B 39/16; F02M 35/10157; F05D 2220/76; F02C 6/12; H02K 7/1823; H02K 7/20; H02K 11/0094; F02B 2039/162; F05D 2220/40; F02D 41/0007

(57) ABSTRACT

A method for controlling an electrical exhaust gas turbocharger of an internal combustion engine includes a measure (a), in accordance with which a load requirement placed on the internal combustion engine is monitored, and a measure (b), in accordance with which a boost mode of the electrical exhaust gas turbocharger is activated if the load requirement monitored in measure (a) exceeds a predetermined threshold value.

### CROSS REFERENCE TO RELATED APPLICATIONS

This application claims priority to Chinese patent application CN 201911415015.3, filed Dec. 31, 2019, the entire content of which is incorporated herein by reference.

### TECHNICAL FIELD

The disclosure relates to a method for controlling an electrified exhaust gas turbocharger of an internal combustion engine, and also relates to a motor vehicle, which comprises an internal combustion engine comprising an electrified exhaust gas turbocharger, and which is equipped to execute such a method in accordance with the disclosure.

### BACKGROUND

Exhaust gas turbochargers have been used for some time to increase the performance of internal combustion engines. Typically, such exhaust gas turbochargers comprise an exhaust gas turbine, which is arranged in an exhaust gas flow module of the internal combustion engine, and a compressor, which is arranged in an intake air flow module of the internal combustion engine. Here the exhaust turbine of the turbocharger converts exhaust gas energy not used by the internal combustion engine and uses it to drive the compressor. The compressor ensures that the charge air flowing through the intake air flow module of the internal combustion engine is compressed such that the boost pressure of the charge air is increased. This means that for a given combustion chamber volume, a larger quantity of air is available to the internal combustion engine for the combustion of a fuel. This achieves the desired increase in performance. In conventional exhaust gas turbochargers, a mechanical drive connection between the exhaust gas turbine and the compressor is provided to transfer the power and energy generated from the exhaust gas with the exhaust gas turbine to the compressor.

However, the efficiency and performance of such exhaust gas turbochargers is typically highly dependent on the volumetric flow of the exhaust gas driving the exhaust turbine. In particular, in the event of a small volumetric flow of exhaust gas, such as occurs in particular at low engine speeds, it is therefore possible that the compressor will achieve only an inadequate boost pressure. This manifests itself in a loss of performance, which is also known to the person skilled in the art as “turbo lag”.

To avoid or reduce the performance losses associated with such turbo lag, mechanical boost pressure control devices have been used in exhaust gas turbochargers for some time. With such a boost pressure control device, which can be implemented in the form of a variable turbine geometry, or a wastegate valve, the characteristic curve of an exhaust gas turbine output can be optimized, so that the efficiency of the exhaust gas turbocharger is improved over a wider range of exhaust gas volumetric flow supplied to the exhaust gas turbine.

To avoid the turbo lag, electrified exhaust gas turbochargers have been used for some time, since the said boost pressure control devices come up against their limits, especially at particularly low engine speeds. Instead of the mechanical drive connection between exhaust turbine and compressor described above, such electrified exhaust gas turbochargers typically comprise an electrical motor, with which the power and energy necessary to generate the required boost pressure can be supplied to the compressor, and an electrical generator, with which the power and energy generated by the exhaust turbine from the exhaust gases can be converted into electrical power and energy. In this way, it is possible to use the electrical power and energy generated by the generator to drive the electrical motor in a flexible manner. Conventional electrified exhaust gas turbochargers are often equipped with an electrical energy storage system, in which the energy generated by the generator, but not required to drive the electrical motor, can be temporarily stored so that it is available at a later point in time for purposes of driving the electrical motor, for purposes of driving the compressor.

In this context, U.S. Pat. No. 6,637,205 B1 discloses an electrically assisted exhaust gas turbocharger, whose exhaust gas turbine has a variable turbine geometry. In addition, the electrically assisted exhaust gas turbocharger has a compressor, mechanically coupled to the exhaust gas turbine via a shaft, and an electrical motor for purposes of power assistance, coupled to the shaft connecting the exhaust gas turbine and the compressor. This means that additional power and energy can be supplied to the compressor with the electrical motor. Here the disadvantage is that the exhaust gas turbine and the compressor are permanently mechanically connected to each other, which is not beneficial at every operating point of the exhaust gas turbocharger, or more particularly, of the internal combustion engine with the exhaust gas turbocharger.

From U.S. Pat. No. 8,813,494 B2 it is of known art that an additional turbine can be introduced into a bypass channel running in parallel, in terms of fluid flow, to the exhaust gas turbine of the turbocharger, with which an electrical generator can be set in operation, if the exhaust gas energy is greater than that required by the compressor to generate the boost pressure. In this case, a disadvantageous level of electrical assistance to the compressor is not possible.

Furthermore, U.S. Pat. No. 7,958,727 B2 discloses an exhaust gas turbine, which is connected by a drive to an electrical generator. Here the electrical generator can be used to generate electrical power and energy, which can be used to drive the electrically driven compressor or electrical traction motors of a motor vehicle, or to charge an electrical energy storage system. The disadvantage here is that no solution is specified as to how the electrified exhaust gas turbocharger can be controlled if a particularly large load is required from the internal combustion engine for a short period of time.

In addition, U.S. Pat. No. 6,647,724 B1 discloses an electrified exhaust gas turbocharger in which an electrical generator is connected by a drive to the exhaust gas turbine. A variable turbine geometry is also present in the exhaust gas turbine. Furthermore, the electrified exhaust gas turbocharger comprises an electrical motor, with which the compressor of the electrified exhaust gas turbocharger can be driven. Power and energy, which can be generated with the electrical generator, can be supplied either to the electrical motor for purposes of driving the compressor, or to an electrical energy storage system. Here too, it is a disadvantage that no solution is specified as to how the electrified exhaust turbocharger is to be controlled if a particularly large load requirement is placed on the internal combustion engine for a short period of time.

### SUMMARY

It is therefore an object of the present disclosure to provide new methods for controlling an electrified exhaust gas turbocharger of an internal combustion engine, as well as for controlling motor vehicles with an internal combustion engine comprising such an electrified exhaust gas turbocharger, in particular so as to eliminate the above cited disadvantages.

This object is achieved by a method for controlling an electrified exhaust gas turbocharger of an internal combustion engine and a vehicle with an internal combustion engine comprising an electrified exhaust gas turbocharger as described herein.

A basic concept of the disclosure is therefore to minimize, with a boost pressure control device of the electrified exhaust gas turbocharger, a fluid flow throttling resistance that is encountered by the flow of the exhaust gas in the course of operation of an internal combustion engine with an electrified turbocharger, if a particularly large, in particular a maximum, load requirement is placed on the internal combustion engine. In this case, a motor connected by a drive to a compressor of the electrified exhaust gas turbocharger is simultaneously supplied with electrical power and energy, for purposes of generating a defined boost pressure. Such a defined boost pressure can be a maximum boost pressure.

Advantageously this enables a particularly rapid fulfilment of a large load requirement placed on the internal combustion engine, which means that the electrified exhaust gas turbocharger can, particularly rapidly, be again operated at, or at least close to, an optimum operating point.

A method in accordance with the disclosure serves to control an electrified exhaust gas turbocharger of an internal combustion engine, which expediently can be comprised in a motor vehicle. The internal combustion engine has an exhaust gas flow module and an intake air flow module. The electrified exhaust gas turbocharger of the internal combustion engine comprises an exhaust gas turbine arranged in the exhaust gas flow module of the internal combustion engine and driven by exhaust gas from the internal combustion engine, which exhaust gas turbine is connected by a drive to an electrical generator. In addition, the electrified exhaust gas turbocharger has a compressor for purposes of the compression of charge air supplied to the internal combustion engine via the intake air flow module, which compressor can be driven by an electrical motor which is, or can be, connected by a drive to the generator. The electrified exhaust gas turbocharger further comprises a boost pressure control device, which expediently can be a wastegate valve, and/or a variable turbine geometry. With the boost pressure control device of the electrified exhaust gas turbocharger, a fluid flow throttling resistance, which is encountered by the flow of the exhaust gas in the course of operation of the internal combustion engine, can be varied. Here the method in accordance with the disclosure comprises a measure a), in accordance with which a load requirement placed on the internal combustion engine is monitored. The method also comprises a further measure b), in accordance with which a boost mode of the electrified exhaust gas turbocharger is activated, if the load requirement monitored in measure a) exceeds a predetermined (first) threshold value. In the boost mode of the electrified exhaust turbocharger, the fluid flow throttling resistance is minimized with the boost pressure control device, and the electrical motor is supplied with electrical power and energy, such that the compressor generates charge air at a maximum boost pressure. The boost mode can be temporarily activated, so that the boost mode is not maintained in a steady, or quasi steady, full load operation of the internal combustion engine. As already indicated above, this offers the advantage that a large load requirement placed on the internal combustion engine can be fulfilled particularly rapidly.

In accordance with an advantageous development of the method, the electrical generator is electrically connected, or can be connected, by a drive to the electrical motor via an interposed, or interposable, electrical energy storage system, so that the energy generated by the generator and stored in the energy storage system is available for purposes of driving the motor at a later point in time. With such an energy storage system, fluctuations in the electrical power/energy that can be generated by the electrical generator, or fluctuations in the electrical power/energy required by the electrical motor, can advantageously be balanced out by buffering.

In a further advantageous development of the method, in the boost mode of the electrified exhaust gas turbocharger, the electrical power and energy to drive the electrical motor is essentially drawn completely from the electrical energy storage system. This advantageously has the consequence that in the boost mode, no electrical power and energy needs to be generated by the electrical generator, so that the electrical generator, or the exhaust gas turbine connected to it, can rotate in a flow of exhaust gas with particularly low resistance and correspondingly with little increase in the throttling resistance.

In accordance with a further preferential development of the method, the method includes a further measure c), in accordance with which a brake mode of the electrified exhaust gas turbocharger is activated if the load requirement monitored in measure a) falls below a predetermined second threshold value, which is less than the first threshold value. In the brake mode of the electrified exhaust gas turbocharger, the fluid flow throttling resistance, which is encountered by the flow of the exhaust gas in the course of operation of the internal combustion engine, is maximized with the boost pressure control device of the electrified exhaust gas turbocharger. Such a load requirement that falls below the second threshold value can expediently be a negative load requirement or a brake requirement. It is therefore advantageous to be able to fulfil a load requirement that falls below the second threshold value particularly rapidly with the aid of a motor brake of the internal combustion engine.

In a further preferential development of the method, the method includes a measure d), in accordance with which the electrified exhaust gas turbocharger is operated in a normal mode if the load requirement monitored in measure a) is equal to or greater than the second threshold value, and equal to or less than the first threshold value. In this normal mode of the electrified exhaust turbocharger, the fluid flow throttling resistance is maintained or varied with the controllable boost pressure control device as a function of the load requirement monitored in measure a). Advantageously. in the normal mode of the electrified exhaust gas turbocharger, this enables a boost pressure, which can be generated with the compressor of the electrified exhaust gas turbocharger, to be generated particularly well in terms of performance and efficiency.

A further advantageous development of the method provides for the activated boost mode to be maintained until the load requirement monitored in measure a) falls below a third threshold value. This third threshold value is less than or equal to the first threshold value, and greater than or equal to the second threshold value. Advantageously, this makes it possible to compensate for an inherent hysteresis, which in principle is caused by the exhaust gas turbocharger, in particular by the inertia of rotating components of the exhaust gas turbocharger.

Expediently the boost mode of the electrified exhaust gas turbocharger activated in measure b) can be deactivated if the load requirement monitored in measure a) falls below the third threshold value. This advantageously enables a particularly efficient operation of the electrified exhaust gas turbocharger.

In accordance with a further preferential development of the method, the electrified exhaust gas turbocharger is operated in the brake mode until the load requirement monitored in measure a) exceeds a fourth threshold value. The fourth threshold value is greater than or equal to the second threshold value, and less than or equal to the first threshold value. Advantageously this enables good compensation for the hysteresis in principle inherent in the exhaust gas turbocharger, which is caused in particular by the inertia of rotating components of the exhaust gas turbocharger.

Expediently the brake mode of the electrified exhaust gas turbocharger activated in measure c) is deactivated if the load requirement monitored in measure a) rises above the fourth threshold value. This enables the electrified exhaust turbocharger to be operated particularly efficiently.

In accordance with a further preferential development of the method, in the boost mode of the electrified exhaust gas turbocharger essentially no electrical power and energy is produced with the electrical generator. Advantageously this has the consequence that the exhaust gas turbine connected by a drive to the electrical generator can rotate with particularly low resistance in the flow of exhaust gas if the boost mode is active. Here, in order to avoid the generation of electrical power and energy by the generator, an electrical connection to any electrical loads connected to the electrical generator, and the electrical connection of the generator by a drive to the electrical motor, can expediently be interrupted.

A further advantageous development of the method, provides for an electrical load on the electrical generator, connected by a drive to the exhaust gas turbine, to be maximized in the brake mode of the electrified exhaust gas turbocharger. Advantageously this has the consequence that the exhaust gas must perform a particularly large amount of work in the exhaust gas turbine, which, while reinforcing a braking effect, advantageously increases the exhaust back pressure acting on the internal combustion engine.

It is expedient for the load requirement monitored in measure a) to be a torque requirement or an acceleration requirement. Such a torque requirement or acceleration requirement can be detected particularly easily.

In accordance with an advantageous development of the method, the controllable boost pressure control device is formed by a variable turbine geometry with adjustable guide vanes, wherein the guide vanes can be adjusted such that the fluid flow throttling resistance varies as a function of their position. Alternatively or additionally, the controllable boost pressure control device is formed by a wastegate valve, with which a bypass channel can be opened such that, in an at least partially opened state of the wastegate valve, at least some of the exhaust gas can be led past the exhaust gas turbine via the bypass channel, thus reducing the fluid flow throttling resistance. Such a boost pressure control device is particularly effective and at the same time easy to implement.

In a preferential development of the method, in measure (b) the boost mode is not activated in steady full load operation of the internal combustion engine, and in particular is deactivated after a predetermined period of time at the latest. Advantageously a complete depletion of the electrical energy storage system can thereby be avoided.

The disclosure also relates to a motor vehicle which comprises an internal combustion engine with an electrified exhaust gas turbocharger. The internal combustion engine has an exhaust gas flow module and an intake air flow module. Here the electrified exhaust gas turbocharger comprises an exhaust gas turbine arranged in the exhaust gas flow module and driven by exhaust gas from the internal combustion engine, which exhaust gas turbine is connected by a drive to an electrical generator. In addition, the electrified exhaust gas turbocharger has a compressor for purposes of the compression of charge air fed to the internal combustion engine via the intake air flow module, which can be driven by an electrical motor, which is, or can be, connected by a drive to the generator. Furthermore, the electrified exhaust gas turbocharger comprises a boost pressure control device, which expediently can be a wastegate valve and/or a variable turbine geometry. With this boost pressure control device, a fluid flow throttling resistance, which is encountered by the flow of the exhaust gas in the course of operation of the internal combustion engine, can be varied. In addition, the internal combustion engine comprises a control/regulation device which is equipped to execute a method in accordance with the above description. The above indicated advantages of the method in accordance with the disclosure are also transferred in an analogous manner to the motor vehicle, which is equipped to execute the method in accordance with the disclosure.

Further important features and advantages of the disclosure ensue from the subsidiary claims, from the figures, and from the associated descriptions based on the figures.

Needless to say, the features cited above, and those yet to be explained below, can be used not only in the combination specified in each case, but also in other combinations, or on their own, without leaving the scope of the present disclosure.

### BRIEF DESCRIPTION OF THE DRAWINGS

The disclosure will now be described with reference to the drawings wherein:

FIG. 1 shows an exemplary embodiment of a motor vehicle in accordance with the disclosure in a layout schematic,

FIG. 2 shows another exemplary embodiment of a motor vehicle in accordance with the disclosure in a layout schematic,

FIG. 3 shows a flow chart of a method in accordance with an exemplary embodiment of the disclosure, and

FIG. 4 shows a flow chart of a method in accordance with another exemplary embodiment of the disclosure.

### DESCRIPTION OF EXEMPLARY EMBODIMENTS

Exemplary embodiments of the disclosure are shown in the figures and are explained in more detail in the following detailed description, wherein identical reference symbols refer to identical, or similar, or functionally identical, components.

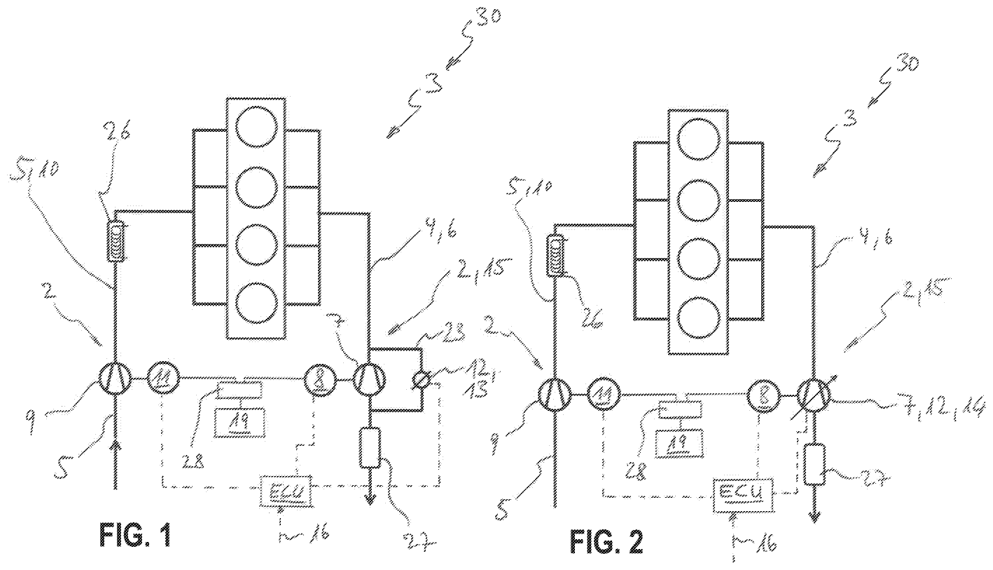

FIG. 1 illustrates a layout of a motor vehicle 30 in accordance with an exemplary embodiment of the disclosure. The motor vehicle 30 has an internal combustion engine 3 with an electrified exhaust gas turbocharger 2. The internal combustion engine 3 also comprises an exhaust gas flow module 4 and an intake air flow module 5. Exhaust gas 6 from the internal combustion engine 3 can flow through the exhaust gas flow module 4. Expediently, charge air 10 can flow through the intake air path 5, which charge air can be supplied to the internal combustion engine 3. The electrified exhaust gas turbocharger 2 has an exhaust gas turbine 7, which is arranged in the exhaust gas flow module 4 of the internal combustion engine 3. In the course of operation of the internal combustion engine 3 the exhaust gas turbine 7 is driven by exhaust gas 6 from the internal combustion engine 3. The electrified exhaust gas turbocharger 2 also comprises an electrical generator 8, which is connected by a drive to the exhaust gas turbine 7. Expediently, the electrical generator 8 is mechanically connected to the exhaust gas turbine 7. In addition, the electrified exhaust gas turbocharger 2 comprises a compressor 9 for purposes of the compression of the charge air 10, which is fed to the internal combustion engine 3 via the intake air flow module 5. In addition, the electrified exhaust gas turbocharger 2 has an electrical motor 11, which is connected by a drive to the compressor 9. The electrical motor 11 can expediently be mechanically connected by a drive to the compressor 9. The generator 8 is connected, or can be connected, not by a mechanical drive, but rather by an electrical drive, to the electrical motor 11. The electrified exhaust gas turbocharger 2 also comprises a boost pressure control device 12. With this boost pressure control device 12 a fluid flow throttling resistance 15, which is encountered by the flow of the exhaust gas 6 in the course of operation of the internal combustion engine 3, can be varied. It can be discerned that the internal combustion engine 3 also comprises a control/regulation device, an ECU. The control/regulation device, or ECU, of the internal combustion engine 3 of the motor vehicle 30, is set up/programmed to execute a method 1 in accordance with the disclosure for the control of the electrified exhaust gas turbocharger 2 of the internal combustion engine 3 of the motor vehicle 30.

In accordance with the exemplary embodiment shown in FIG. 1, the boost pressure control device 12 of the electrified exhaust gas turbocharger 2 is designed as a wastegate valve 13. With the wastegate valve 13, a bypass channel 23 can be opened up in terms of fluid flow, so that in a partially open state of the wastegate valve 13, at least some of the exhaust gas 6 can be led past the exhaust gas turbine 7 via the bypass channel 23. This is accompanied by a reduction of the fluid flow throttling resistance 15, which is encountered by the flow of the exhaust gas 6 in the course of operation of the internal combustion engine 3.

FIG. 2 illustrates another exemplary embodiment of a motor vehicle 30 in accordance with the disclosure, with an internal combustion engine 3 comprising an electrified exhaust gas turbocharger 2. The exemplary embodiment shown in FIG. 2 differs from that in FIG. 1 in that the boost pressure control device 12 is formed by a variable turbine geometry 14. The variable turbine geometry 14 has adjustable guide vanes. Here the adjustable guide vanes of the variable turbine geometry 14 can be adjusted such that the fluid flow throttling resistance 15 alters as a function of their position. Expediently the guide vanes of the variable turbine geometry 14 can be adjusted such that their adjustment is accompanied by a change in a flow cross section of the exhaust gas 6 flowing through the variable turbine geometry 14, which causes a change in the throttling resistance 15.

FIGS. 1 and 2 also show that the temperature of the charge air 10 that can be led through the intake air flow module 5 can be altered with a charge air cooler 26 located in the intake air flow module 5. In addition, an exhaust gas catalytic converter 27 can be present in the exhaust gas line 4 for the aftertreatment of the exhaust gas 6. It can also be discerned that the electrical generator 8 is electrically connected, or can be connected, by a drive to the electrical motor 11 via an intermediate, or what can be an intermediate, electrical energy storage system 19, so that the energy generated by the generator 8 and stored in the energy storage system 19 is available for purposes of driving the motor 11 at a later point in time. The electrical motor 11 and the electrical generator 8 can be electrically connected to the electrical energy storage system 19 with power electronics 28. The power electronics 28 can comprise an electrical converter. The power electronics 28 can comprise an AC-DC/DC-AC converter. The power electronics 28 can be equipped to distribute an electrical load to the electrical components connected to the latter.

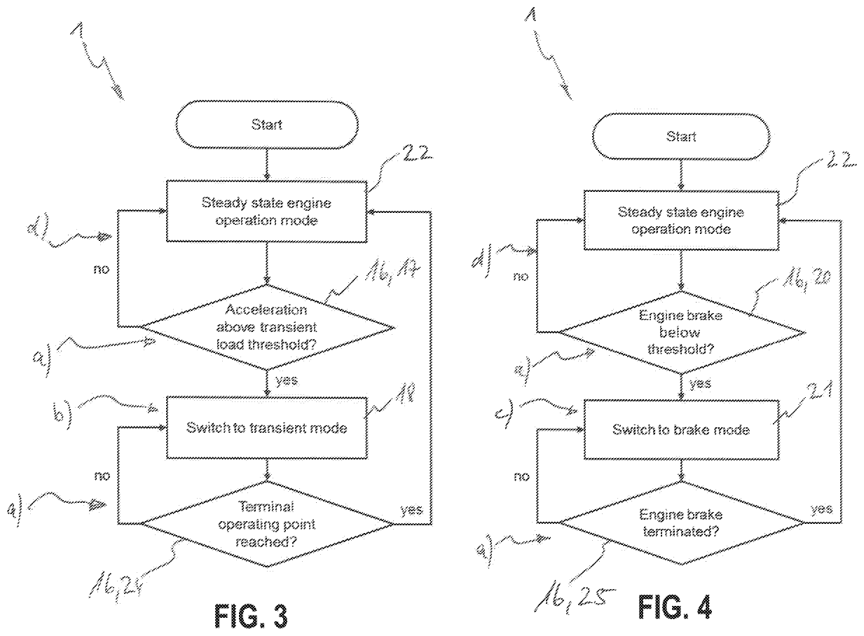

FIG. 3 illustrates in an exemplary flow chart the sequence of a method 1 in accordance with the disclosure for the control of the electrified exhaust gas turbocharger 2 shown in FIGS. 1 and 2.

The method 1 comprises a measure a), in accordance with which a load requirement 16 placed on the internal combustion engine 3 is monitored. Typically, such a load requirement 16 for the internal combustion engine 3 is specified by the driver of a motor vehicle 30 comprising the internal combustion engine 3. Expediently, the load requirement 16 monitored in measure a) can be a torque requirement or an acceleration requirement.

The method 1 also comprises a measure b), which is undertaken if the load requirement 16 monitored in measure a) exceeds a predetermined first threshold value 17. If this condition is fulfilled, a boost mode 18 of the electrified exhaust gas turbocharger 2 is activated in accordance with measure b). In the boost mode 18 of the electrified exhaust gas turbocharger 2, the fluid flow throttling resistance 15, which is encountered by the flow of the exhaust gas 6 in the course of operation of the internal combustion engine 3, is minimized with the boost pressure control device 12. In the case in which the boost pressure control device 12 comprises a wastegate valve 13, this is achieved in that with the wastegate valve 13 a bypass channel 23 is connected, in terms of fluid flow, in parallel with the exhaust gas turbine 7; this connection is accompanied by an increase in a flow cross section of the flow of the exhaust gas 6, reducing the throttling resistance 15. In the case in which the boost pressure control device 12 has a variable turbine geometry 14, the minimizing of the throttling resistance 15 is achieved by moving guide vanes of the variable turbine geometry 14 into a maximum open position, in which a maximum flow cross section is achieved for the flow of the exhaust gas 6, and thus a minimum throttling resistance 15. At the same time, in the boost mode 18 the electrical motor 11 is supplied with electrical power and energy such that the compressor 9, connected by a drive to the electrical motor 11, generates charge air 10 with a maximum boost pressure. In the boost mode 18, the electrical power and energy for purposes of driving the electrical motor 11 is essentially drawn completely from the electrical energy storage system 14.

FIG. 4 shows another exemplary embodiment of a method 1 in accordance with the disclosure in a flow chart. It can be discerned that the method additionally comprises a measure c). The said measure c) ensures that if the load requirement 16 monitored in measure a) falls below a predetermined second threshold value 20, which is less than the first threshold value 17, a brake mode 21 of the electrified exhaust gas turbocharger 2 is activated. In this brake mode 21 of the electrified exhaust turbocharger 2, the fluid flow throttling resistance 15 is maximized with the boost pressure control device 12.

FIGS. 3 and 4 also show that the method 1 comprises a further measure d). In accordance with measure d), the electrified exhaust gas turbocharger 2 is operated in a normal mode 22, if the load requirement 16 monitored in measure a) is equal to or greater than the second threshold value 20, and equal to or less than the first threshold value 17. In the normal mode 22 of the electrified exhaust turbocharger 2, the fluid flow throttling resistance 15 is maintained or varied with the controllable boost pressure control device 12 as a function of the load requirement 16 monitored in measure a).

It also follows from FIG. 3 that the activated boost mode 18 is maintained until the load requirement 16 monitored in measure a) falls below a third threshold value 24. This third threshold value 24 is less than or equal to the first threshold value 17, and greater than or equal to the second threshold value 20. Here the boost mode 18 of the electrified exhaust gas turbocharger 2 activated in measure b) is deactivated, if the load requirement 16 monitored in measure a) falls below the third threshold value 24.

It can be discerned from FIG. 4 that the electrified exhaust gas turbocharger 2 is operated in brake mode 21 until the load requirement 16 monitored in measure a) exceeds a fourth threshold value 25. The fourth threshold value 25 is greater than or equal to the second threshold value 20, and less than or equal to the first threshold value 17. The brake mode 21 of the electrified exhaust gas turbocharger 22 activated in measure c) is deactivated if the load requirement 16 monitored in measure a) exceeds the fourth threshold value 25.

In the boost mode 18, the electrical generator 8 produces essentially no electrical power or energy. This is expediently achieved by interrupting an electrical connection to electrical loads electrically connected to the generator 8, and the electrical drive connection to the electrical motor 11. This means that expediently the electrical generator 8 is not loaded electrically in the boost mode 18. In contrast, in the brake mode 18 of the electrified exhaust gas turbocharger 2, an electrical load on the electrical generator 8, connected by a drive to the exhaust gas turbine 7, is maximized. In measure b), the boost mode 18 is not activated in steady full load operation of the internal combustion engine 30. To this end, the boost mode 18 can be again deactivated after a predetermined period of time at the latest.

It is understood that the foregoing description is that of the exemplary embodiments of the disclosure and that various changes and modifications may be made thereto without departing from the spirit and scope of the disclosure as defined in the appended claims.

What is claimed is:

1. A method for controlling an electrified exhaust gas turbocharger of an internal combustion engine, in particular of a motor vehicle, the internal combustion engine including an exhaust gas flow module and an intake air flow module, the electrified exhaust gas turbocharger including an exhaust gas turbine, arranged in the exhaust gas flow module and driven by exhaust gas from the internal combustion engine, which exhaust gas turbine is connected by a drive to an electrical generator, the electrified exhaust gas turbocharger including a compressor for the compression of charge air supplied to the internal combustion engine via the intake air flow module, which compressor can be driven by an electrical motor, which is connected, or can be connected, by a drive to the generator, the electrified exhaust gas turbocharger having a boost pressure control device, in particular a wastegate valve and/or a variable turbine geometry, with which a fluid flow throttling resistance, which is encountered by the flow of the exhaust gas in the course of operation of the internal combustion engine, can be varied, the method comprising:
(a) monitoring a load requirement placed on the internal combustion engine; and
(b) if the load requirement monitored in measure (a) exceeds a predetermined (first) threshold value: activating a boost mode of the electrified exhaust gas turbocharger, in which the fluid flow throttling resistance is minimized with the boost pressure control device, and the electrical motor is supplied with electrical power and energy such that the compressor generates charge air at a maximum boost pressure.

2. The method according to claim 1, wherein the electrical generator is electrically connected, or can be connected, by a drive to the electrical motor via an interposed, or interposable, and chargeable, electrical energy storage system, such that the energy generated by the generator and stored in the energy storage system is available for driving the motor at a later point in time.

3. The method according to claim 2, wherein in the boost mode, the electrical power and energy for driving the electrical motor is completely drawn by the latter from the electrical energy storage system.

4. The method according to claim 1, further comprising:
(c) if the load requirement monitored in measure (a) falls below a predetermined second threshold value, which is less than the first threshold value: activating a brake mode of the electrified exhaust gas turbocharger, in which the fluid flow throttling resistance is maximized with the boost pressure control device.

5. The method according to claim 4, further comprising:
(d) if the load requirement monitored in measure (a) is equal to or greater than the second threshold value, and equal to or less than the first threshold value: operating the electrified exhaust gas turbocharger in a normal mode in which the fluid flow throttling resistance is maintained or varied with the controllable boost pressure control device as a function of the load requirement monitored in accordance with measure (a).

6. The method according to claim 1, wherein the activated boost mode is maintained until the load requirement monitored in accordance with measure (a) falls below a third threshold value, which is less than or equal to the first threshold value and is larger than or equal to the second threshold value.

7. The method according to claim 6, wherein if the load requirement monitored in measure (a) falls below the third threshold value, the boost mode of the electrified exhaust gas turbocharger activated in measure (b) is deactivated.

8. The method according to claim 4, wherein the electrified exhaust gas turbocharger is operated in brake mode until the load requirement monitored in accordance with measure (a) exceeds a fourth threshold value, which is larger than or equal to the second threshold value, and less than or equal to the first threshold value.

9. The method according to claim 8, wherein if the load requirement monitored in measure (a) rises above the fourth threshold value, the brake mode of the electrified exhaust gas turbocharger activated in measure (c) is deactivated.

10. The method according to claim 1, wherein in the boost mode, no electrical power and energy is produced by the electrical generator.

11. The method according to claim 4, wherein in the brake mode of the electrified exhaust gas turbocharger, an electrical load on the electrical generator connected by a drive to the exhaust gas turbine is maximized.

12. The method according to claim 1, wherein the load requirement monitored in measure (a) is a torque requirement or an acceleration requirement.

13. The method according to claim 1, wherein:
the controllable boost pressure control device is formed by a variable turbine geometry with adjustable guide vanes, wherein the guide vanes can be adjusted such that the fluid flow throttling resistance alters as a function of their position; and/or
the controllable boost pressure control device is formed by a wastegate valve, with which a bypass channel can be opened such that in an at least partially opened state of the wastegate valve at least some of the exhaust gas can be led past the exhaust gas turbine via the bypass channel, with a reduction in the fluid flow throttling resistance.

14. The method according to claim 1, wherein in measure (b) the boost mode is not activated in steady full load operation of the internal combustion engine, and in particular is deactivated after a predetermined period of time at the latest.

15. A vehicle comprising:
an internal combustion engine, the internal combustion engine comprising:
an electrified exhaust gas turbocharger;
an exhaust gas flow module; and
an intake air flow module,
wherein the electrified exhaust gas turbocharger comprises an exhaust gas turbine arranged in the exhaust gas flow module, and driven by exhaust gas from the internal combustion engine, which exhaust gas turbine is connected by a drive to an electric generator,
wherein the electrified exhaust gas turbocharger comprises a compressor for purposes of the compression of charge air supplied to the internal combustion engine via the intake air flow module, which compressor can be driven by an electrical motor, which is connected, or can be connected, by a drive to the generator,
wherein the electrified exhaust gas turbocharger has a boost pressure control device, in particular a wastegate valve, and/or a variable turbine geometry, with which a fluid flow throttling resistance, which is encountered by the flow of the exhaust gas in the course of operation of the internal combustion engine, can be varied, and
wherein the internal combustion engine comprises a control/regulation device (EPU) which is equipped to execute the method according to one of the preceding claims.
